(19) United States
(12) Patent Application Publication
(10) Pub. No.: US 2015/0117801 A1
(43) Pub. Date: Apr. 30, 2015

(54) Fabric for making bags

(71) Applicant: BSW Machinery Handels-GmbH, Wien (AT)

(72) Inventor: Peter Schmalholz, Achau (AT)

(21) Appl. No.: 14/395,712

(22) PCT Filed: Apr. 9, 2013
(86) PCT No.: PCT/AT2013/000060

§ 371 Date: Oct. 20, 2014

(30) Foreign Application Priority Data
Apr. 23, 2012 (AT) A 492/2012

(51) Int. Cl. B32B 5/26; B65D 30/08; B32B 7/02

(52) U.S. Cl. CPC B32B 5/26; B32B 7/02; B65D 29/02; B32B 2262/0253; B32B 2255/02; B32B 2255/26; B32B 2250/02
USPC 383/117; 428/137

(57) ABSTRACT

A woven fabric (1) for the production of bags includes tapes of polymer, such as polyolefin, polypropylene, polyethylene (HDPE) or polyethylene terephthalate, that are preferably monoaxially stretched. The fabric is provided with a coating. The coating is formed of a polymer non-woven.

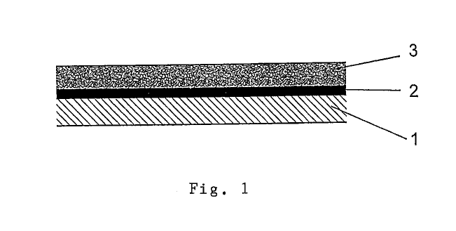

The invention relates to a woven fabric for the production of bags, comprised of tapes of polymer, in particular polyolefin, polypropylene, polyethylene (HDPE) or polyethylene terephthalate, said tapes being preferably monoaxially stretched, wherein the fabric is provided with a coating.

The invention further relates to a bag made of such fabric.

The tubular body of a valve bag is usually formed of a tubular round material or a flat material that is connected on its longitudinal edges to form a tube. A rough classification of such bags is made by distinguishing between pillow and box shapes. A pillow-shaped bag is usually made by assembling the bottoms by a textile seam or a weldseam. With a box-shaped bag, at least one end comprises a bottom fold such that the bag has a substantially rectangular bottom. The present invention relates to pillow shapes and box shapes alike.

The woven fabric is preferably comprised of monoaxially stretched tapes of polymer, in particular polyolefin or polypropylene. These tapes are made by stretching polymer, in particular polyolefin or polypropylene, films to four to ten times their original lengths, thus causing the molecular chains to be oriented in the longitudinal direction of the tapes and, in these directions, exhibit a strength about six to ten times higher than that of the original film. The tape width is usually about 1.5 to 10 mm, their thickness 20 to 80 μm. In order to achieve a density against dust and moisture, the woven fabric, on one or two sides, usually has a coating of a melt preferably of the same material as the tapes.

Valve bags are characterized in that a valve formed of the fabric material is integrated in the bottom of the bag, via which valve the bag, which is closed on both sides, can be filled with filling material. Filling is performed in that a pipe socket-shaped mouthpiece of a filling plant is introduced into the valve. In doing so, the valve is spread open so as to allow the filling material to be filled into the valve bag. When the predetermined filling quantity has been filled into the bag, the latter is drawn off the pipe socket-shaped mouthpiece of the filling plant. While this is done, the valve is to close by the tube wall regions of the valve tubing coming to lie against each other, which is realized in that the valve tubing is compressed by the pressure exerted by the filling material.

During the filling procedure, the evacuation of air from the interior of the bag is required. With paper bags, such deaeration occurs over the entire bag surface, since paper shows some air permeability, as a rule. At the same time, paper is dust-proof even without coating. The great disadvantage of paper bags, however, is their limited stability and, in particular, resistance to tearing.

By contrast, bags made of a coated woven fabric comprised of monoaxially stretched tapes of polymer, in particular polyolefin or polypropylene, are extremely tear-proof and stable. Yet, such bags having moisture-tight or dust-tight coatings require the fabric to be perforated in order to ensure the necessary deaeration. Although attempts have been made to dimension the number and diameter of the perforations such that the required deaeration performance will be achieved while simultaneously avoiding excessive deterioration of the dust-holding capacity, the result has always been a compromise between the two conflicting requirements of the deaeration performance and the dust-holding capacity.

The present inventions, therefore, aims to further develop a woven fabric of the initially defined kind in such a manner that the dust-holding capacity will be improved while an adequate deaeration performance will, at the same time, be maintained.

A further problem with woven fabrics of the initially defined kind is their weldability. Thus, it has, for instance, become usual to close the bottom fold of a box-shaped bag by welding a cover sheet of a fabric comprised of monoaxially stretched tapes of polymer, in particular polyolefin, preferably polypropylene, to the same. This is done in some embodiments by using an intermediate layer of thermoplastic material, in particular polyolefin and, preferably, polypropylene material (cf., e.g. WO 95/30598 A1). Welding, however, involves the drawback that the introduction of heat, which is inevitable during welding, causes a disorientation of the molecules of the plastic tapes, which were oriented by monoaxial stretching. Fabric regions containing disoriented molecules have a substantially lower strength as compared to regions including oriented molecules such that there will be a risk of the fabric tearing open in the region of the weld. Disorientation can at best be prevented by a sufficiently thick coating of the fabric. Yet, this will result in a relatively high weight of the bag and elevated costs.

Therefore, the present invention, moreover, aims to further develop a fabric of the initially defined kind in such a manner as to enhance its weldability without increasing the mass per unit area of the fabric and without involving the risk of the material molecules becoming disoriented.

To solve these objects, the invention in a woven fabric comprised of monoaxially stretched tapes of polymer, in particular polyolefin or polypropylene, and provided with a coating contemplates that the coating is formed of a polymer non-woven, in particular polyolefin or polypropylene non-woven. Polymer non-woven in this context is meant to denote a flat textile product formed of individual polymer fibers. It is, in particular, an entangled fiber fabric, in which the individual polymer fibers are laid in a disoriented fashion, i.e. the fibers are randomly distributed in the non-woven fabric. Said non-woven fabric is, in particular, designed as a spun-bonded fabric. Non-wovens offer the advantage of largely preventing the penetration of dust without substantially influencing the deaeration performance. In particular, if the fabric plus coating comprises a plurality of perforations, as in correspondence with a preferred further development, the individual fibers of the non-woven will act like a filter on the surface in the region of the perforations, holding back the dust particles. The dust particles entrained by the air flow during deaeration are thus caught in the non-woven fabric, and are thereby prevented from passing through the non-woven. It has thus become possible to make the perforations larger and provide them in a reduced number while keeping the same aeration performance so as to reduce the manufacturing expenses. A preferred configuration in this context provides that the woven fabric comprises 10-60, in particular 20-50, perforations per cm². The diameter of the perforations is at least 0.05 mm, preferably at least 0.1 mm.

Another advantage of the non-woven fabric is that it contributes more to an increase in the strength of the fabric than a conventional coating, thus enabling the fabric to be designed with a reduced mass per unit area at an unchanged overall strength. Since the non-woven is available at lower costs than the woven fabric, cost savings will therefore be achieved.

A further effect resides in that the non-oriented fibers of the non-woven are fixed in their positions by the bond with the fabric, which will increase the strength of the coated fabric.

On the side of the non-woven, the composite material according to the invention can be excellently welded with a similar material without noticeably reducing the strength of the material. The reason for this is that the fiber molecules of the non-woven are only stretched to a slight extent such that the disorientation caused by the introduction of heat will not significantly affect the strength of the non-woven. The orientation of the stretched tapes of the woven fabric will remain unaffected in any event.

A particularly advantageous configuration of the invention provides that the polymer non-woven, in particular polypropylene non-woven, is applied all over the woven fabric. Alternatively, it is, however, also possible to apply the polymer non-woven, in particular polypropylene non-woven, only partially on the fabric, i.e. only on specific points and, with a tubular fabric, for instance, only on part of its circumference, in particular on half of its circumference.

In a preferred manner, it is further provided that the polymer non-woven, in particular polypropylene non-woven, is applied on the fabric via an intermediate layer. This will ensure a safe and stable bond between the woven fabric and the non-woven. The intermediate layer may in this case be comprised of the same polymer as the fabric and the polymer non-woven. In a particularly simple manner, it is proceeded such that the intermediate layer is applied by extrusion lamination.

When the woven fabric is coated with a non-woven as in accordance with the invention, the fabric can be designed with a reduced mass per unit area as already indicated above, without affecting the strength of the composite material. In this respect, it is preferably provided that the woven fabric has a mass per unit area of 40-60 g/m², the intermediate layer has a mass per unit area of 10-20 g/m², and the polymer non-woven has a mass per unit area of 20-40 g/m². According to a particularly advantageous configuration, the woven fabric has a mass per unit area of 50 g/m², the intermediate layer has a mass per unit area of 15 g/m², and the polymer non-woven has a mass per unit area of 25-30 g/m².

Concerning the ratio of the masses per unit area of the individual layers relative to one another, it has turned out that a configuration in which the woven fabric has a mass per unit area corresponding to 1.5-2.5 times the mass per unit area of the polymer non-woven is preferred.

The coated fabric according to the invention can be used for the production of bags for transporting, in particular, powdery filling material. However, other applications are conceivable as well, e.g. for the production of tarpaulins, covers, etc.

When used in a bag, the polymer non-woven is preferably disposed on the outer side of the bag. That is, in particular, a box-shaped bag, wherein at least one end region of the bag body comprises a bottom fold such that the bag has a substantially rectangular bottom. That is, in particular, a block bottom valve bag, whose bottom comprises a valve formed, in particular, of the bottom fabric material such that the bag, which is already closed by the manufacturer, can be filled via said valve in conventional filling plants.

In the following, the invention will be explained in more detail by way of an exemplary embodiment schematically illustrated in the drawing. In the FIGURE, the layered structure of the coated fabric according to the invention is illustrated. The structure comprises a woven fabric 1 comprised of monoaxially stretched polypropylene tapes, the mass per unit area of the woven fabric being 50 g/m². The intermediate layer 2 consists of polypropylene and can be applied onto the fabric by extrusion lamination. The coating of the fabric web is preferably performed as described in WO 2011/094783 A1. The mass per unit area of the intermediate layer is 15 g/m². In the not yet solidified state of the intermediate layer, the polypropylene non-woven 3 is applied onto the latter and connected to the intermediate layer by an integral joint. The polypropylene non-woven has a mass per unit area of about 25 g/m². It is apparent that all of the three layers are made of polypropylene such that a single-type composite material is provided, which can be recycled without problems after use.

The non-woven is, in particular, designed as a spun-bonded non-woven. To produce the fibers therefor, a polymer is heated and pressurized in an extruder. The polymer is pressed through a die, which is called spinneret, in an exact dose by spin pumps. The polymer exits from the spinneret plate in the still molten state as a fine thread (filament). It is cooled by an air flow and stretched from the melt. The air flow transports the filaments onto a conveyor belt, which is designed as a screen. The threads are fixed by being sucked off below the screen belt. The formed fiber mat is a randomly oriented non-woven web that has to be solidified. The solidification can be effected by two heated rollers (calender) or by a vapour flow. During the solidification by a calender, one of the two rollers is usually provided with an engraving formed by points, short rectangles or diamond-shaped dots. The filaments fuse together on the contact points, thus forming the non-woven fabric.

In order to produce a bag from the coated fabric, it is proceeded as follows. In a first step, either a woven fabric web (flat fabric) coated with the non-woven on one side is taken and formed into a tube with the non-woven coming to lie on the outer side. Or an uncoated, tubular woven fabric (circular fabric), or an uncoated flat woven fabric formed into a tube, is taken and the intermediate layer is laminated onto the tube by extrusion lamination in a conventional coating installation (cf. WO 2011/094783 A1), followed by the application of the non-woven. In a second step, the coated tubular fabric is perforated. In a third step, the tubular bag body is closed at least on one side. To produce a block bottom valve bag, the bag body is, in particular, provided with a bottom fold on both ends, and a cover sheet is welded onto the bottom fold. In one of the two bottom folds, a valve made, in particular, of the fabric is integrated.

1. A woven fabric for the production of bags comprising tapes of polymer, in particular polyolefin, polypropylene, polyethylene (HDPE) or polyethylene terephthalate, said tapes being monoaxially stretched, fabric provided with a coating formed of a polymer non-woven, wherein the fabric plus coating comprises a plurality of perforations.

2-15. (canceled)

16. A woven fabric according to claim 1, wherein the polymer non-woven is a polyolefin or polypropylene non-woven.

17. A woven fabric according to claim 1, wherein the polymer non-woven is applied all over the fabric.

18. A woven fabric according to claim 1, wherein said woven fabric has an intermediate layer between the fabric and the coating, whereby said polymer non-woven is applied on the fabric via said intermediate layer.

19. A woven fabric according to claim 17, wherein the polymer non-woven is a polypropylene non-woven.

20. A woven fabric according to claim 18, wherein the polymer non-woven comprises a spun-bonded fabric.

21. A woven fabric according to claim 18, wherein the intermediate layer is comprised of the same polymer as the fabric and the polymer non-woven.

22. A woven fabric according to claim 18, wherein the intermediate layer is applied by extrusion lamination.

23. A woven fabric according to claim 1, wherein the fabric comprises 10-60 perforations per cm².

24. A woven fabric according to claim 1, wherein the fabric comprises 20-50 perforations per cm².

25. A woven fabric according to claim 1, wherein the diameter of the perforations is at least 0.05 mm.

26. A woven fabric according to claim 1, wherein the diameter of the perforations is at least 0.1 mm.

27. A woven fabric according to claim 18, wherein the fabric has a mass per unit area of 40-60 g/m², the intermediate layer has a mass per unit area of 10-20 g/m², and the polymer non-woven has a mass per unit area of 20-40 g/m².

28. A woven fabric according to claim 12, wherein the fabric has a mass per unit area of 50 g/m², the intermediate layer has a mass per unit area of 15 g/m², and the polymer non-woven has a mass per unit area of 25-30 g/m².

29. A woven fabric according to claim 1, wherein the fabric has a mass per unit area corresponding to 1.5-2.5 times the mass per unit area of the polymer non-woven.

30. A woven fabric according to claim 1, wherein the tapes are selected from the group consisting of polypropylene tapes, polyethylene (HDPE) tapes and polyethylene terephthalate tapes, said polymer non-woven comprises a polypropylene non-woven, said fabric comprises a plurality of perforations in the range of 20-50 perforations per cm², the fabric has a mass per unit area of 50 g/m², the intermediate layer has a mass per unit area of 15 g/m², and the polymer non-woven has a mass per unit area of 25-30 g/m².

31. A bag comprising, or comprised of, a coated woven fabric according to claim 1, wherein the polymer non-woven is disposed on the outer side of the bag.

32. A bag according to claim 31, wherein at least one end region of the bag body comprises a bottom fold such that the bag has a substantially rectangular bottom.

33. A bag according to claim 31, wherein the bag is designed as a block bottom valve bag, whose bottom comprises a valve.

34. A bag according to claim 33, wherein the valve is made of the bottom fabric material.
